(19) United States
(12) Patent Application Publication
(10) Pub. No.: US 2026/0310436 A1
(43) Pub. Date: Oct. 8, 2026

(54) INTEGRATING MULTIPLE SOFTWARE PROGRAMS USING A LANDING ZONE CONFIGURATION MODULE AND AN INTEGRATION PATTERN MODULE

(71) Applicant: Insight Direct USA, Inc., Chandler, AZ (US)

(72) Inventor: Paul William Smithdale, Perth (AU)

(21) Appl. No.: 19/474,793

(22) PCT Filed: Apr. 13, 2023
(86) PCT No.: PCT/US2023/018429

§ 371 Date: Oct. 13, 2025

(51) Int. Cl. G06F 8/61; G06F 9/50; G06F 9/54

(52) U.S. Cl. CPC G06F 8/61; G06F 9/5072; G06F 9/5077; G06F 9/54

(57) ABSTRACT

A method of integrating multiple software programs with one another to allow for communication therebetween can include defining resource information regarding integration resources in a cloud platform for use in integrating the multiple software programs with the resource information being defined in a landing zone configuration module, defining an integration process in an integration pattern module with the integration pattern module referencing the resource information in the landing zone configuration module, uploading the landing zone configuration module and the integration pattern module to a container repository having storage media on the cloud platform, generating a first integration module having information specific to the integration of a first software program with the first integration module referencing the landing zone configuration module and the integration pattern module, automatically downloading, by a computer processor, the landing zone configuration module and the integration pattern module to the first integration module.

### CROSS-REFERENCE TO RELATED APPLICATION

This application is a Section 371 National Stage Application of International Application No. PCT/US2023/018429, filed on Apr. 13, 2023, entitled “INTEGRATING MULTIPLE SOFTWARE PROGRAMS USING A LANDING ZONE CONFIGURATION MODULE AND AN INTEGRATION PATTERN MODULE,” which is incorporated herein by reference in its entirety.

### FIELD OF THE INVENTION

The disclosure relates generally to the integration of software programs, and more specifically, to the use of multiple modules during the integration process to define integration resource information and an integration pattern for use multiple times in the integration of multiple software programs.

### BACKGROUND

The development and deployment of an integration platform that allows multiple different software programs to communicate with one another and work in combination is a complex and time-consuming process that includes receiving information from each program, formatting that information, and transmitting the formatted information for use by another software program. Creating this process for multiple software programs having multiple different receive endpoints, send endpoints, individual mapping/routes from one schema/format of one program to another schema/format of another program, and/or permissions is difficult for a development team tasked with creating the integration platform. Thus, it is advantageous to simplify this process across all integrations of software programs into the integration platform to reduce time, expense, and resource requirements.

### SUMMARY

A method of integrating multiple software programs with one another to allow for communication therebetween can include defining resource information regarding integration resources in a cloud platform for use in integrating the multiple software programs with the resource information being defined in a landing zone configuration module, defining an integration process in an integration pattern module with the integration pattern module referencing the resource information in the landing zone configuration module, uploading the landing zone configuration module and the integration pattern module to a container repository having storage media on the cloud platform, generating a first integration module having information specific to the integration of a first software program with the first integration module referencing the landing zone configuration module and the integration pattern module, automatically downloading, by a computer processor, the landing zone configuration module and the integration pattern module to the first integration module, and deploying the first integration module to the cloud platform that effectuates the integration of the first software program through use of the integration resources in the cloud platform with the integration resources being set out in the resource information in the landing zone configuration module.

A system for integrating multiple software programs with one another to allow for communication therebetween can include a landing zone configuration module that defines resource information regarding integration resources in a cloud platform for use in integrating the multiple software programs, an integration pattern module that defines a core integration process and that references the resource information in the landing zone configuration module, an integration module having information specific to the integration of a first software program with the integration module referencing the landing zone configuration module and the integration pattern module, a computer processor that automatically downloads the landing zone configuration module and the integration pattern module to the integration module such that all information within the landing zone configuration module and the integration pattern module are in the integration module at the time of deployment, and the cloud platform to which the integration module is deployed to effectuate the integration of the first software program through the use of integration resources in the cloud platform with the integration resources being set out in the resource information in the landing zone configuration module.

### BRIEF DESCRIPTION OF THE DRAWINGS

FIG. 1A is a schematic of an example integration system for integrating a software program using a cloud platform.

FIG. 1B is an example of a process for integrating a software program to enable communication between multiple software programs.

FIG. 2 is example software code having integration resource information defined within a landing zone configuration module.

FIG. 3 is a schematic of an example integration pattern as defined within an integration pattern module.

While the above-identified figures set forth one or more examples of the present disclosure, other examples/embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and examples of the present invention may include features and components not specifically shown in the drawings.

### DETAILED DESCRIPTION

Systems and related methods are disclosed herein for developing an integration to allow multiple software programs to exchange information between each other automatically and in a format that is acceptable and useable by each software program. The disclosed integration systems and methods can be configured to use a cloud platform (such as Microsoft Azure, Google Cloud Platform, Amazon Web Services, or others) to store data, perform instructions regarding integration, and effectuate the integration of the software programs. The integration systems and methods can use multiple software code/data modules, such as Bicep modules, to store and send data to an integration platform and/or cloud platform (which can include a subscription, one or multiple landing zones, a workload configuration, and other components for accessing and managing the use of integration resources within the cloud platform) for performance of the integration of the software program.

The term “integration” is used herein to describe the enablement of one software program to communicate information/data with another software program. “Integration” can include, but is not limited to, reformatting information/data from one software program into a format that is acceptable and useable by another program. For example, the systems and methods can provide for the integration of a first software program with a second software program. In this example, the first software program can be a program that schedules meetings, and the second software program can be a communication program (such as a video conferencing program) that automatically provides communication capabilities (such as a website link that connects users to a video conference) depending on the meeting that is scheduled via the first software program. Thus, in this example, the first software program provides meeting information to the integration platform, which in turn provides that information to the second software program in a format that is useful/acceptable to the second software program. The second software program can provide communication information to the integration platform, which in turn provides that information to the first program in a format that is useful/acceptable to the first program. In such a way, these programs are integrated with one another so as to be able to communicate information/data with one another. Such an integration may require the performance of two integration processes to set up: one for enabling communication of the first software program with the second software program and another for enabling communication of the second software program with the first software program.

An integration workload module defines the infrastructure resources (e.g., an infrastructure) that form a landing zone for each environment within which the integration is to take place. The infrastructure resources provide compute, storage, and communication infrastructure that can be used to host integration-specific resources and software programs, such as a logic app or function app to which information/data can be saved and/or one or multiple computer processors can be present to perform tasks/instructions for the integration of the software program.

A landing zone configuration module defines resource information, such as the names/locations of the infrastructure and/or integration resources to be used for each environment of the integration (e.g., a development environment, a test environment, and a production environment), while an integration pattern module defines the core integration pattern that establishes the integration process for each integration of each software program. The landing zone configuration module and the integration pattern module can be uploaded to the container registry in the cloud platform for access by other components of the integration system.

For each software program that is to be integrated, an integration module is generated and/or created that can include information specific to the integration of the particular software program (and of a second software program with which the first software program is to communicate) as well as integration software code that provides instructions to the integration resources, such as the function app, to perform the integration. This information can include add-ons to the integration pattern set out in the integration pattern module so as to create an integration pattern specific to the integration of the software program and designed specifically for the software program. The information specific to the integration in the integration module can also include specific parameters detailing to which environment (e.g., development, test, or production) the integration of the software program is to be added/introduced. The integration module can reference the landing zone configuration module and the integration pattern module to use the information within both of those modules. For example, the integration module can use the landing zone configuration module to set out the names/locations of the underlying infrastructure for hosting integration resources, while the integration module uses the integration pattern module to define integration resources that are to be used to perform the integration of the software program.

The integration module for the specific program is then deployed to the cloud platform for performance of the instructions therewithin for integration of the software program into the integration platform (i.e., allowing communication of the software program with another software program). However, before deployment, the landing zone configuration module and the integration pattern module can be downloaded to the integration module such that information for integrating the software program is contained within the integration module. Once deployed, the cloud platform uses integration resources to effectuate the integration of the software program into the integration platform by performing the instructions within the integration module. The integration module defines which resources within the cloud platform are to perform which tasks, where the information regarding the integration of the software program is stored, and/or other information and/or instructions.

The generation and/or creation of the integration module to integrate one software program with another (e.g., to enable communication of information/data from one software program to another) may be required for each specific program that is to be integrated (i.e., communication enabled between two programs). For example, if the integration platform includes five software programs that communicate with one another, the addition of a sixth software program that is to communicate with the other five software programs may use the integration process, including generating an integration module, five times to allow the communication of the new software program with the five software programs that are already integrated.

The integration process, however, is made easier and quicker due to the use of the landing zone workload module, the landing zone configuration module, and the integration pattern module disclosed herein. The creation and/or formulation of the landing zone workload module, the landing zone configuration module, and the integration pattern module is not required each time the integration process is performed to integrate each program. Rather, the landing zone workload module, the landing zone configuration module, and the integration pattern module can remain the same for each integration process, and the three modules can be used by each new integration module that is generated for each integration process for integrating each software program with another software program. Each new integration module merely needs to reference the already generated and established landing zone configuration module (to set out the names/locations of the resources to be used for that particular integration) and the already established integration pattern module (to set out the core integration pattern to be used for that particular integration). Each new integration module does not need to define this information (i.e., the information in the landing zone configuration module and the information in the integration pattern module) within the integration module. Thus, the generation of each new integration module is less burdensome and time-consuming, which is advantageous because the integration platform can be developed to include dozens or hundreds of integrations (e.g., many software programs can be integrated into the integration platform). These and other advantages will be realized by reviewing the below disclosure.

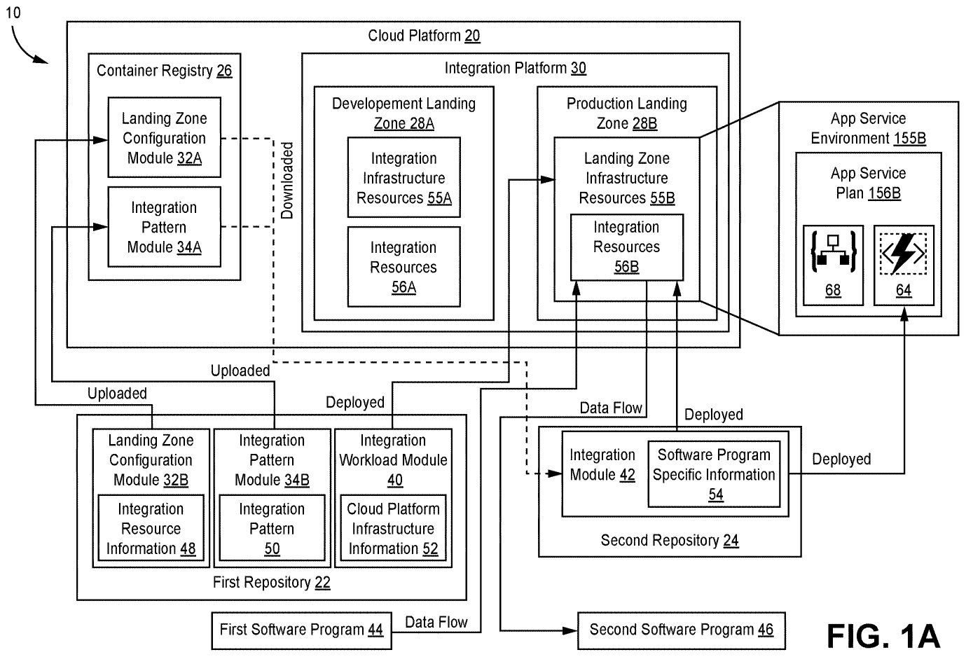

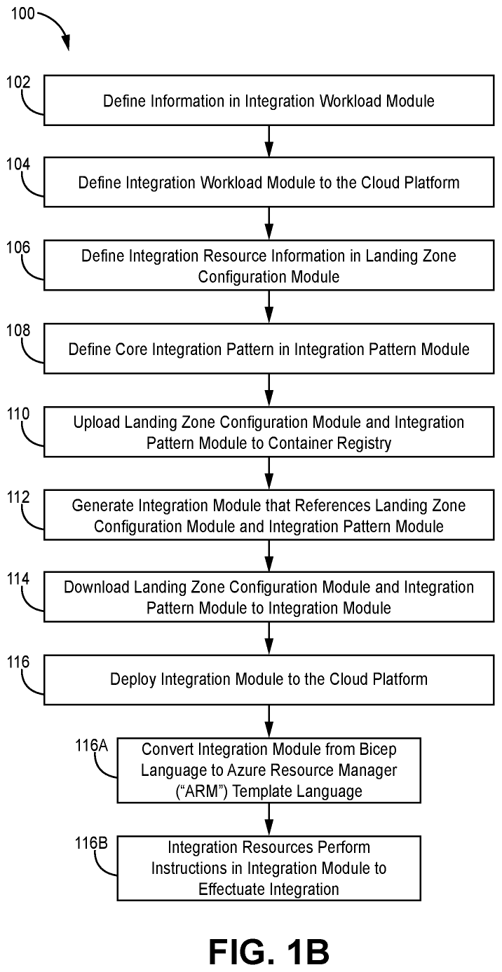

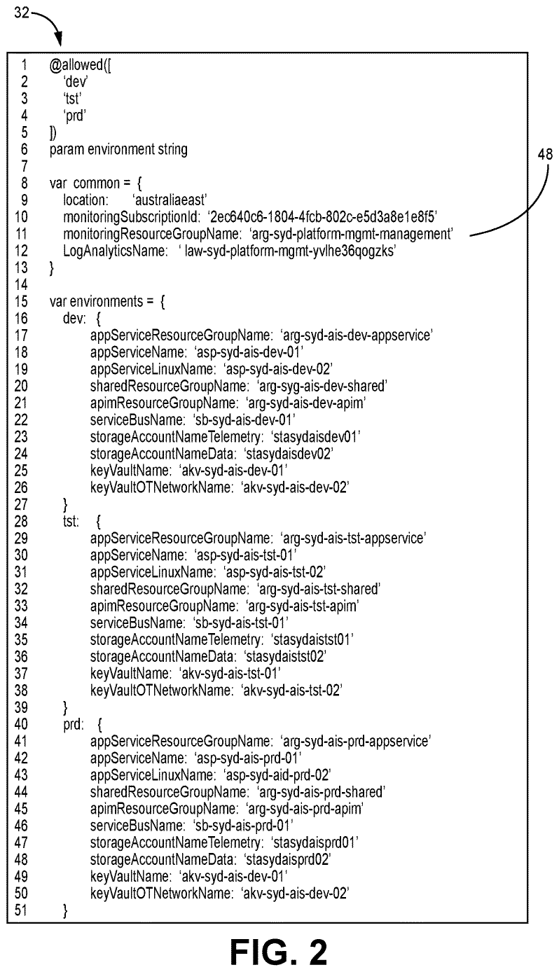

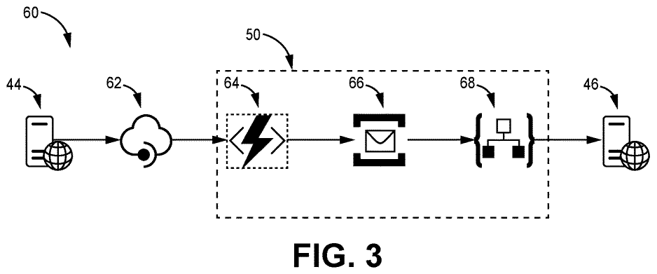

FIG. 1A is a schematic of an example of an integration system for integrating a software program using a cloud platform to enable communication between multiple software programs, while FIG. 1B is an example of a process for integrating the software program. FIG. 2 is a schematic of example integration resource information defined within a landing zone configuration module, and FIG. 3 is a schematic of an example integration pattern as defined within an integration pattern module.

Integration system 10 as shown in FIG. 1A can include cloud platform 20, first repository 22, and second repository 24. Cloud platform 20 can include container registry 26 and integration platform 30 having development landing zone 28A and production landing zone 28B (collectively, “landing zone 32”). Container registry 26 can include, after upload, landing zone configuration module 32A and integration pattern module 34A. First repository 22 can include, before upload, landing zone configuration module 32B, integration pattern module 34B, and integration workload module 40. Second repository 24 can include integration module 42. Integration system 10 is suitable for enabling communication/integration of first software program 44 with second software program 46 (and vice versa). Landing zone configuration module 32 (both 32A and 32B) can include integration resource information 48. Integration pattern module 34 (both 34A and 34B) can include core integration pattern 50. Integration workload module 40 can include cloud platform infrastructure information 52, and integration module 42 can include software program specific information 54. Development landing zone 28A can include integration infrastructure resources 55A having integration resources 56A and production landing zone 28B can include landing zone infrastructure resources 55B having integration resources 56B. Integration infrastructure resources 55A and landing zone infrastructure resources 55B (collectively, “infrastructure resources 55) can provide infrastructure for the use of cloud platform 20, and each can include/designate integration resources 56A and/or 56B (collectively, “integration resources 56”).

Integration platform 30 is shown in FIG. 1A as an example having two environments within which integration can take place: the development environment (in development landing zone 28A) and the production environment (in production landing zone 28B). In the example shown in FIG. 1A, integration workload module 40, integration module 42, first software system 44, and second software system 46 are in communication with (e.g., upload information to and/or provide data and/or information to and from) resources in production landing zone 28B, including landing zone infrastructure resources 55B and/or integration resources 56B. However, these components can be in communication with development landing zone 28A in a similar fashion. The schematic omits these lines for simplicity, but the systems and/or processes described herein with regards to production landing zone 28B are similar to those used with development landing zone 28A. In example FIG. 1A, landing zone infrastructure resources 55B is shown as including app service environment 155B and app service plan 156B, integration resources 56B are shown as having logic app 68 and function app 64.

Integration system 10 (and the disclosed integration process 100 shown and described with regards to FIG. 1B) can include other steps, components, configurations, and/or features not expressly disclosed herein that are suitable for integrating multiple software programs with one another (i.e., enabling multiple software programs to communicate/exchange information with one another). For example, integration system 10 can include any number of digital/electronic storage media for storing data/information, any number of computer processors for performing tasks/instructions with regards to integration system 10, communication element(s) (i.e., wired or wireless communication) that enable communication between components of integration system 10 and/or between software programs distant from integration system 10, and/or other components.

Integration system 10 (e.g., any of the components of integration system 10, such as integration platform 30) can send and receive information from various components within and/or distant from integration system 10, such as multiple software programs that are integrated by/into integration platform 30 (e.g., first software program 44 and/or second software program 46). Each of these software programs can provide information to integration system 10 and/or any components of integration system 10 (e.g., cloud platform 20 and/or integration system 30) that is modified and sent to one, multiple, or all other software programs for use by those computer programs. For example, the computer programs are integrated with one another and provide information to and can receive information from one another in a format that is acceptable by the other computer programs.

In the example shown in FIG. 1A, integration system 10 is configured to integrate first software program 44 with second software program 46, such that first software program 44 operates in conjunction with second software program 46, and is able to send information/data to second program 46 is used by second program 46. While shown in the example of FIG. 1A as integrating first software program 44 with second software program 46, integration system 10 can integrate and accommodate any number of software programs. As is described in this disclosure, the integration process can be easily and efficiently replicated for each additional software program that is integrated into integration system 10 (e.g., integration platform 30). First software program 44 and/or second software program 46 can be any software programs that are to be integrated with one another and/or with other programs. The integration process to enable communication (e.g., the exchange of information) between software programs can be set out in integration module 42 and can be performed by cloud platform 20 (e.g., by integration platform 30), as is further described below. The development and implementation of the integration process is described as an example in FIG. 1B.

Integration system 10 and/or any of the components of integration system 10 (e.g., cloud platform 20 and/or integration platform 30) can be a discrete assembly or be formed by one or more devices capable of individually or collectively implementing the functionalities described herein. In some examples, integration system 10 can be implemented as a plurality of discrete circuitry subassemblies. In some examples, integration system 10 can include and/or be implemented as downloadable software in the form of a mobile application. The mobile application can be implemented on a computing device, such as a personal computer, tablet, or smartphone, among other suitable devices. Integration system 10 (e.g., any of the components of integration system 10) may be considered to form a single computing device even when distributed across multiple component devices.

Integration system 10, including cloud platform 20, can include one or multiple computer/data processors. In general, the computer/data processors can include any one or more of a processor, a microprocessor, a controller, a digital signal processor (DSP), an application specific integrated circuit (ASIC), a field-programmable gate array (FPGA), or other equivalent discrete or integrated logic circuitry. The computer processors can perform instructions stored/located within any of modules 32, 34, 40, and/or 42 and/or stored/located within storage media (located on/within integration system 10, cloud platform 20, or located elsewhere). In some examples, the computer processors can include storage media, such that the computer processors are able to store instructions and perform the functions described herein. Additionally, the computer processors can perform other computing processes described herein as merely being performed by integration system 10 and/or cloud platform 20 (including infrastructure resources 55 and/or integration resources 560.

Integration system 10 and/or any components of integration system 10 (such as cloud platform 20 and/or integration platform 30) can include a user interface, which can include or be implemented on an input and/or output device. The user interface can enable an operator to create, edit, view, and/or otherwise control the operation of integration system 10. For example, the user interface can be configured to receive inputs from an operator and/or provide outputs. The user interface can include one or more of a sound card, a video graphics card, a speaker, a display device (such as a liquid crystal display (LCD), a light emitting diode (LED) display, an organic light emitting diode (OLED) display, etc.), a touchscreen, a keyboard, a mouse, a joystick, or other type of device for facilitating input and/or output of information in a form understandable to users and/or machines. The user interface can be used to create, copy, modify, or otherwise manipulate any of modules 32, 34, 40, and/or 42 and/or other components of integration system 10.

Integration system 10 and/or any of the components of integration system 10 (such as cloud platform 20 and/or integration platform 30) can include one or multiple electronic/digital storage media that is configured to store information and, in some examples, can be described as a computer-readable storage medium. In some examples, a computer-readable storage medium can include a non-transitory medium. The term “non-transitory” can indicate that the storage medium is not embodied in a carrier wave or a propagated signal. In certain examples, a non-transitory storage medium can store data that can, over time, change (e.g., in RAM or cache). In some examples, the storage media is a temporary memory. As used herein, a temporary memory refers to a memory having a primary purpose that is not long-term storage. The storage media, in some examples, is described as volatile memory. As used herein, a volatile memory refers to a memory that does not maintain stored contents when power to the storage media is turned off. Examples of volatile memories can include random access memories (RAM), dynamic random access memories (DRAM), static random access memories (SRAM), and other forms of volatile memories. In some examples, the storage media is used to store program instructions for execution by the processor. The storage media, in one example, is used by software or applications running on cloud platform 20 (e.g., integration resources 56) to temporarily store information during program execution (e.g., during integration).

The storage media, in some examples, also includes one or more computer-readable storage media. The storage media can be configured to store larger amounts of information than volatile memory. The storage media can further be configured for long-term storage of information. In some examples, the storage media includes non-volatile storage elements. Examples of such non-volatile storage elements can include, for example, magnetic hard discs, optical discs, floppy discs, flash memories, or forms of electrically programmable memories (EPROM) or electrically erasable and programmable (EEPROM) memories.

One, multiple, or all components of integration system 10 can be stored or otherwise contained on/within cloud platform 20. Cloud platform 20 can be a collective of cloud-based services and/or products accessible for storage, computing, security, etc. by a client/user. Cloud platform 20 can be any system for providing services and/or products to a client/user, such as Microsoft Azure, Google Cloud Platform, Amazon Web Services, or another cloud platform. Cloud platform 20 can include a variety of services and/or products, referred to herein as resources (e.g., infrastructure resources 55 and/or integration resources 56), including one or multiple computer processors, digital storage media/memory (such as container registry 26, first repository 22, and/or second repository 24), user interfaces, application programming interfaces, services buses, logic apps, function apps, repositories, key vaults, and/or a variety of other services and/or products as is known to one of skill in the industry.

Cloud platform 20, with resources 55 and/or 56, can store data/information (e.g., within container registry 26, first repository 22, and/or second repository 24), perform tasks/commands/instructions (e.g., perform the integration of first software program 44 with second software program 46 by performing the tasks/instructions set out in integration module 42), provide system security (e.g., through the use of key vaults, subscriptions, etc.), and/or have other capabilities and/or functions not expressly described herein but known to one of skill in the industry. All components, functions, and capabilities of integration system 10 can be within and/or performed by cloud platform 20 such that the integration of first software program 44 with second software program 46 and the continued operation of integration platform 30 are performed by integration resources 56 of cloud platform 20. Thus, while shown as being separate from cloud platform 20 in FIG. 1A, first repository 22 and/or second repository 24 and the modules therein can be created, edited, stored, etc. within cloud platform 20. In another example, first repository 22 and/or second repository 24 are separate from cloud platform 20, and the modules are deployed/uploaded to cloud platform 20 during the integration process.

First repository 22 and/or second repository 24 can store and/or allow for generation, creation, copying, and/or editing of modules 32B, 34B, 40, and/or 42. Repositories 22 and 24 can have storage media, computer processors, and/or other components not expressly disclosed herein. Repositories 22 and/or 24 can be configured to track all changes made to modules 32B, 34B, 40, and/or 42 with regards to integration system 10, and can save this data in a directory and/or repository. For example, repositories 22 and/or 24 can each be a version control system. Repositories 22 and/or 24 can have any configurations and/or capabilities necessary to allow for the generation, creation, alteration (as well as the tracking of alterations/changes), and/or storage of modules 32B, 34B, 40, and/or 42 before deployment/upload to cloud platform 20.

Modules 32B, 34B, 40, and 42 can be stored within repositories 22 and 24, respectively, before being deployed/uploaded to cloud platform 20. Modules 32B, 34B, 40, and 42 can each be embodied in one or more computer files that can include any type of information, such as resource definitions, information regarding the location of storage media, other files, software programs, security, permissions, etc. Additionally, modules 32B, 34B, 40, and 42 can include software code, which can include instructions for performing the integration of software programs in integration platform 30 and/or cloud platform 20 as well as performing other functions of integration system 10. Modules 32B, 34B, 40, and/or 42 can have any configuration and/or software code that is written in any coding language. In one example, modules 32B, 34B, 40, and 42 are written in Bicep language (a domain-specific language by Microsoft), and integration module 42 is converted to Azure Resource Manager (“ARM”) template language before or during deployment to cloud platform 20. In another example, modules 32B, 34B, 40, and 42 are written in Terraform language. The language of modules 32B, 34B, 40, and 42 can be converted/transpiled to any other language accepted by cloud platform 20, and integration system 10 can include conversion/transpiling capabilities as needed.

As described below, each of modules 32B, 24B, 40, and 42 can have a variety of configurations and/or contain information/data, instructions, etc. useful for integration of software programs in integration platform 30. The specific configurations and/or information of each module 32B, 34B, 40, and 42 as described below are merely examples, and the modules can include other configurations, information, functionalities, etc. not expressly disclosed herein.

Integration workload module 40 can include cloud platform infrastructure information 52 that can define infrastructure resources 55A and 55B within cloud platform 20 that are to be used to integrate the software programs (e.g., that are used to store data, perform instructions, etc. to integrate the software programs with one another in, for example, integration platform 30). Cloud platform infrastructure information 52 can detail resources in cloud platform 30, labeled in FIG. 1A as integration resources 56A and 56B, that are to be used by integration system 10. Integration workload module 40 can be written in any programming language, including Bicep language, and can include software code.

For example, integration resources 56B can receive the deployed integration module 42 and perform the tasks/instructions detailed therein to effectuate the integration of first software program 44 with second software program 46 in the production environment, and integration resources 56B can receive information/data from first software program 44, perform the various integration instructions to reformat the information/data (and potentially perform other operations on the information/data), and provide the information/data to second software program 46 in a format that is useable/acceptable by second software program 46.

Additionally, cloud platform infrastructure information 52 also can detail/select the configuration, organization, etc. of integration resources 56 (e.g., which resources are to be used by integration system 10 for which storage, operations, etc. for each environment/landing zone). Integration resources 56, as defined by integration workload module 40 in cloud platform infrastructure information 52, can be any number of resources (e.g., services and/or products offered by cloud platform 20) necessary to effectuate the integration of the software programs. Each landing zone 28 can use the same infrastructure resources 55 and/or integration resources 56 (e.g., landing zones 28 have shared infrastructure). Integration module 42 can instruct integration platform 30 as to which resources are to be deployed/used on the shared infrastructure (as potentially defined in integration workload module 40 and deployed to integration platform 30) to effectuate the integration. Cloud platform infrastructure information 52 in integration workload module 40 can also include/define the service plan of the user as well as other profile information regarding access to and/or use of cloud platform 20 by the user/client.

Integrated workload module 40 can be deployed/uploaded to each landing zone 28 of cloud platform 20. Each landing zone 28 can include a subscription to allow access to a user's/client's portfolio and/or landing zone, such as in an app service environment 115B. Each landing zone 28, which can be within cloud platform 20, can be the output of a multi-subscription cloud platform environment (such as app service environment 115B) that provides for, among other capabilities, scale, security governance, networking, and/or identity authentication. Each landing zone 28 can be an environment for hosting the workloads (e.g., infrastructure) as provided by integration workload module 40. Each landing zone 28 can include and/or grant access to integration platform 30, infrastructure resources 55, and/or integration resources 56. Each landing zone 28 can have other capabilities not described herein, such as those known to one of skill in the industry.

Cloud platform infrastructure information 52, as set out in integration workload module 40, can define the infrastructure resources 55 and/or integration resources 56 of cloud platform 20. Cloud platform infrastructure information 52 can define the integration resources 56 for use in storing landing zone configuration module 32A and/or integration pattern module 34A. In the example shown in FIG. 1A, the integration resource for storage of modules 32A and/or 34A is defined as container registry 26. The designation of container registry 26 by integration workload module 40 and the deployment of integration workload module 40 to cloud platform 20 may be performed before the upload of landing zone configuration module 32 and integration pattern module 34 to cloud platform 20 so that the destination within cloud platform 20 where modules 32 and 34 are to be uploaded is known (e.g., container registry 26 in this example). Integration workload module 40 can include other software code and/or data/information for defining infrastructure resources 55 and/or integration resources 56, allowing access to cloud platform 20 by user/client (e.g., by integration system 10), and detailing the infrastructure of integration resources 56, landing zones 28, and/or integration platform 30, as well as other information.

Landing zone configuration module 32 (shown as module 32B in first repository 22 before upload and as module 32A in container registry 26 after upload, but collectively referred to herein as “landing zone configuration module 32”) can include software code in the Bicep language or another language. Landing zone configuration module 32 can include integration resource information 48 that defines resource information regarding integration workload module(s) 40 each deployed to landing zones 28 in cloud platform 20 for use in integrating the software programs. Example integration resource information 48 of landing zone configuration module 32 is shown in FIG. 2. Integration resource information 48 can detail the names and/or locations of infrastructure resources 55A and/or 55B that can be used to host integration resources 56A and/or 56B, respectively, to integrate the software programs. As shown in FIG. 2, for example, integration resource information 48 can include, among others: application service resource group name, application service name, app service Linux name, shared resource group name, application programming interface management resource group name, service bus name, storage account name telemetry, storage account name data, key vault name, and key vault network name. This information can be provided in integration resource information 48 for each environment to which the integration of software program is to be added, such as a development environment (for use in developing the integration process of software programs, which is set out in development landing zone 28A), a test environment (for testing the integration of software programs with one another), and a production environment (for operation of the integration process/system that integrates the software programs, which is set out in production landing zone 28B), or other environments to which the software program is to be integrated. In FIG. 2, the development environment information is shown as “dev,” the test environment information is shown as “tst,” and the production environment information is shown as “prd.” Integration resource information 48 defined in landing zone configuration module 32 can also include other, non-environmental, information/variables/parameters, such as location, monitoring subscription identification, monitoring resource group name, and/or log analytics name. Thus, landing zone configuration module 32 can include an extended list/definition of integration resources that can be used in integration system 10 and that can be referenced in integration module 42 for use in the specific integration process set out in the particular integration module 42. Landing zone configuration module 32 can include information that is different than that shown in the example in FIG. 2 and/or can include other information than that which is expressly disclosed herein.

After all relevant information is defined within landing zone configuration module 32B, landing zone configuration module 32B is uploaded to container registry 26 and is saved/stored as landing zone configuration module 32A for access by cloud platform 20 and/or integration module 42. Additionally, a copy of landing zone configuration module 32A (e.g., integration resource information 48) can be downloaded to integration module 42. Integration resource information 48 in landing zone configuration module 32 need only be generated once during the integration process, and this information can be used (e.g., can be downloaded) multiple times by multiple integration modules 42 each time a new software program is integrated during the integration process. Accordingly, the information set out in landing zone configuration module 32 does not need to repeatedly be generated/written in each integration module 42, therefore saving much time and effort in integrating new software programs in integration platform 30.

Integration pattern module 34 (shown as module 34B in first repository 22 before upload and as module 34A in container registry 26 after upload, but collectively referred to herein as “integration pattern module 32”) can include software code in the Bicep language or another language. Integration pattern module 34 can include integration pattern/process 50, which is the process/instructions that set out the steps for integrating the software program with another software program in integration platform 30. An example of integration pattern 50 is shown in FIG. 3, which uses logic app 64 and function app 68 (among other resources, such as service bus 66).

In FIG. 3, total integration process 60 includes receiving information/messages from first software program 46 by gateway 62 (such as an application programming interface), communicating the information to function app 64, then routing the information through service bus 66, dequeuing the information to logic app 68, and finally sending that information to second computer program 46 for use by second computer program 46. Integration pattern/process 50 as set out in integration pattern module 34 can be a subset of total integration process 60, and can include function app 64, service bus 66, and logic app 68. In the example integration process described herein, all integrations of software programs by integration system 10 use this core integration pattern 50 having function app 64, service bus 66, and logic app 68. Integration module 42 can build upon this core integration pattern 50 by adding new steps/programs/resources to integrate the specific software program with another software program. Other configurations of integration system 10 and/or the integration process can include an integration pattern 50 that is different (e.g., includes more or less steps/elements) than the one described with respect to FIG. 3. Integration pattern module 34 can include other information in addition to defining integration pattern/process 50, and any information and/or software code can reference any information in landing zone configuration module 32 in place of providing/defining that information in integration pattern module 34.

After the relevant information is defined within integration pattern module 34B (or the information is in landing zone configuration module 32 and referenced by integration pattern module 34B), integration pattern module 34 is uploaded to container registry 26 (either at the same time as landing zone configuration module 32 or at another time) and is saved/stored as integration pattern module 34A for access by cloud platform 20 and/or integration module 42. Additionally, a copy of integration pattern module 34B (e.g., having core integration pattern 50) can be downloaded to integration module 42. As with landing zone configuration module 32, integration pattern 50 and other information in integration pattern module 34 need only be defined once during the integration process, and this information can be used (e.g., can be downloaded) multiple times by multiple integration modules 42 each time a new software program is integrated during the integration process. Thus, the information set out in integration pattern module 34 does not need to be repeatedly defined in each integration module 42, therefore saving much time and effort in integrating new software programs in integration platform 30. This savings in time and effort can be substantial, as integration pattern 50 can be quite complex, and the development of integration pattern 50 can be burdensome for the developer tasked with developing the integration process (e.g., creating the integration module 42) for each integration of each software program. Moreover, techniques of integration pattern 50 described herein provide consistency throughout the code base associated with the integration, thereby helping to decrease errors or other deficiencies in the code base while also improving reliability and maintainability of the integration code (e.g., the code within modules 32, 34, 40, and/or 42 for effectuating the integration).

Integration workload module 40, landing zone configuration module 32, and/or integration pattern module 34 can be created at any time before the generation or creation of integration module 42 to provide the building blocks and infrastructure used by the integration process to perform the integration of software programs. Because these building blocks (e.g., configurations, definitions, etc.) and infrastructure are already defined and/or in place when integration module 42 is generated or created, the development of integration module 42 and the deployment of integration module 42 to cloud platform 20 is simple and fast.

Integration module 42 can be generated, created, modified, and/or stored in second repository 24 before deployment/upload to cloud platform 20, or integration module 42 can be generated, created, modified, and/or saved in another location, such as at the same location as modules 32B, 34B, and/or 40. Integration module 42 can include software code in the Bicep language or another language, and can include software program specific information that is specific to the integration of the software program that is to be integrated (in the example shown in FIG. 1A, specific to first software program 44). This information can include additional steps to integration pattern 50 set out in integration pattern module 34. For example, integration module 42 can include information to define that the integration pattern has a step in which the logic app sends the information to four additional application programming interface gateways, and one of those gateways sends the information to second software program 46, while the other gateways further process or otherwise route the information. Instead of writing the integration pattern from scratch in integration module 42, a portion of integration pattern 50 (e.g., a core integration pattern) can be referenced in integration pattern module 34 by integration module 42, and integration module 42 merely needs to build upon this core integration pattern 50 as defined in integration pattern module 34A.

Other software program specific information 54 can include information associated with the environment (e.g., which landing zone 28) to which first software program 44 is to be integrated, such as a development environment, a test environment, and/or a production environment. As described above, depending on the environment selected/designated in software program specific information 54, the integration resources 56 used by integration module 42 for first software program 44 are defined in landing zone configuration module 32A. Thus, instead of listing/defining the resources information for the designated environment, integration module 42 merely needs to reference that information in landing zone configuration module 32A.

Integration module 42 can include other software program specific information 54, such as parameters and/or instructions for downloading landing zone configuration module 32A and/or integration pattern module 34A into integration module 42, converting/transpiling integration module 42 into another coding language (such as ARM template language), and/or deploying integration module 42 to landing zone(s) 28, integration platform 30, and/or other components/nodes in cloud platform 20.

Before being deployed to cloud platform 20, integration module 42 can include a command that prompts one or multiple integration resources 56 (or other components) to download landing zone configuration module 32A and/or integration pattern module 34A to integration module 42 so that integration module 42 contains all information necessary to integrate first software program 44 with another software program (represented in FIG. 1A as a dotted line). In one example, the referencing of information in landing zone configuration module 32A and in integration pattern module 34A is replaced in integration module 42 with that referenced information. In another example, the information in landing zone configuration module 32A and in integration pattern module 44A that was referenced in integration module 42 is added to integration module 42 as a reference table or in a similar fashion.

Integration module 42 can be deployed (i.e., uploaded) to cloud platform 20 upon completion of the generation of integration module 42, which can include creating integration module 42 from scratch and/or copying some or all of integration module 42 from a previously created integration module 42 or another program/node/element/module, and the downloading of landing zone configuration module 32A and/or integration pattern module 34A. Deployment of integration module 42 includes performing instructions detailed in integration module 42 by cloud platform 20 and, specifically, by the integration resources 56 as defined in integration module 42 (originally defined in landing zone configuration module 32 but then downloaded to and contained in integration module 42). The instructions performed by integration resources 56 as detailed in integration module 42 can be the integration pattern/process that sets out the process by which first software program 44 is integrated in, for example, integration platform 30 (e.g., by which first software program 44 is enabled to communicate with second software program 46). These instructions can continuously be performed to continuously allow for communication between first software program 44 and second program 46, and the instructions can be saved in cloud platform 20 for continual use.

The integration of first software program 44 with second software program 46 is described herein as being performed in and/or by integration resources 56 of cloud platform 20. Integration resources 56 are described in this disclosure as the components where the integration of the software programs is continually performed after integration system 10 has finished the development process of adding the integration of software program such that the software program can send information to and receive and use information from other software programs (i.e., after a software program has been integrated into a system that includes other software programs). Thus, the process is performed by integration resources 56 to first integrate first software program 44 with second program 46 and then continually enable the communication of first software program 44 with second software program 46. Integration resources 56 are on/within cloud platform 20 generally and are used by integration platform 30 to perform tasks/instructions, store information/data, and for other functions and/or capabilities. The schematic of FIG. 1A merely shows an organizational structure of cloud platform 20, integration platform 30, infrastructure resources 55, and integration resources 56 for descriptive purposes and does not require the nesting of those components within one another.

For example, integration system 10 does not need to include integration platform 30, and the resources necessary for performing the tasks for the integration of first software program 44 with second software program 46 as well as the continual tasks for continuous communication between integrated software programs can be performed generally by cloud platform 20 using integration resources 56 as designated by the various components of integration system 10. Cloud platform 20 can have any organization or configuration to perform the necessary tasks to enable communication of information from first software program 44 to second software program 46.

Integration system 10 can perform various processes for integrating software programs with one another (i.e., to allow for information/data from first software program 44 to be communicated in a useable/acceptable format to second software program 46), with an example described herein with regards to FIG. 1B as integration process 100. Integration process 100 can include other steps not expressly disclosed herein and/or can include the steps in other orders than those shown in FIG. 1B, such as gaining and/or granting access to cloud platform 20, setting up a user profile and/or portfolio for cloud platform 20, and/or selecting subscription plans for cloud platform 20 before or during any of the steps in integration process 100.

FIG. 1B is an example of integration process 100 detailing the method of integrating a software program to allow for communication between multiple software programs. Steps 102-110 (related to integration workload module 40, landing zone configuration module 32, and integration pattern module 34) do not need to be performed each time a new software program is integrated, while steps 112-116 (related to integration module 42) may need to be performed for each new software program to integrate (e.g., communicate) with another software program. Thus, for first software program 44 and second software program 46 to communicate with one another, steps 112-116 may need to be performed twice (to enable information from first software program 44 to be used/accepted by second software program 46 and to enable information from second software program 46 to be used/accepted by first software program 44). Accordingly, for first software program 44 to communicate with (send information to and receive information from) four other software programs, steps 112-116 may need to be performed eight times (i.e., integration module 42 having information specific to the integration of first software program 44 with each of the other software programs would need to be generated eight times). Therefore, to have an integration system/platform that includes many software programs able to communicate with one another, at least a portion of integration process 100 may need to be performed dozens or more times. However, the complex, resource-intensive, and time-consuming steps 102-110 do not need to be performed for every integration, providing significant advantages as compared to prior art systems and methods. While process 100 is described herein with regards to integration system 10 shown in FIG. 1A, process 100 can be performed by any system having any components, capabilities, configurations, and/or functionalities suitable for performing steps 102-116.

First, integration process 100 includes step 102, which is defining information in integration workload module 40. This information can include cloud platform infrastructure information 52. Step 102 can include defining/detailing landing zones 28, infrastructure resources 55, and/or integration resources 56 in cloud platform 20 that are to be used in performance of the integration of the software programs. Step 102 can also include defining/detailing the configuration, organization, etc. of integration resources 56 within integration workload module 40. Cloud platform infrastructure information 52 in integration workload module 40 can also include/define the service plan of the user as well as other profile information regarding the access to and/or use of cloud platform 20 by the user/client.

After step 102, process 100 includes step 104, which is deploying integration workload module 40 to cloud platform 20. Integration workload module 40 can be deployed (which can include uploading a file that is the integration workload module 40 having/including cloud platform infrastructure information 52) to, for example, each of landing zones 28 of cloud platform 20. Upon deployment/upload of integration workload module 40, the infrastructure of integration resources 56 is designated, which can include designating the location to which landing zone configuration module 32 and integration pattern module 34 are to be stored/saved (e.g., container registry 26).

Step 106 can include defining integration resource information 48 in landing zone configuration module 32B. Integration resource information 48 can define resource information regarding infrastructure 55 and/or integration resources 56 in cloud platform 20 for use in integrating the software programs, as shown in FIG. 2. Integration resource information 48 can include any of the information shown in example landing zone configuration module 32 in FIG. 2 and/or additional or other information regarding, among other things, which integration resources 56 are to be used for integration of software programs into different environments (e.g., development, test, and production environments). Step 106 can include fully creating landing zone configuration module 32B, such as writing software code and/or other information, and/or generating or copying a portion of or all of landing zone configuration module 32B from another source.

Step 108 can include defining core integration pattern 50 in integration pattern module 34B. Core integration pattern 50 can be the process/instructions that set out the steps for communicating information from one software programs with one another. An example of core integration pattern 50 is shown in FIG. 3. Step 108 can include defining multiple core integration patterns 50 as well as other information regarding the process of exchanging information from one software programs to another. Step 108 can include fully creating integration pattern module 34B, such as writing software code and/or other information, and/or generating or copying a portion or all of integration pattern module 34B from another source.

After steps 106 and 108 that generate and/or create modules 32B and/or 34B that define integration resource information 48 and integration pattern 50, respectively, process 100 can include step 110, which is uploading landing zone configuration module 32B and integration pattern module 34B to cloud platform 20 (e.g., uploading to container registry 26). Step 110 can be performed for each module 32B or 34B separately such that step 110 is performed twice at two different times, or step 110 can be performed for both modules 32B and 34B simultaneously or in quick succession. Step 110 can first create copies of modules 32A and/or 34A, and then upload the copies of modules 32 and/or 34 to container registry 26 so as to leave the original modules 32A and/or 34A in first repository 22 for later use in another integration system 10 and/or integration process 100. Step 110 can be performed by one or multiple integration resources 56 of cloud platform 20 or by another component, such as one or multiple computer processors local to first repository 22 (or another location at which modules 32A and/or 34A are stored), local to a user/client, or at another location.

As mentioned above, steps 102-110 only need to be performed once to establish the building blocks, infrastructure, and/or other information upon which integration of multiple software programs are performed. The information set out in steps 102-110 can be repeatedly used by each integration module 42 that is generated for the integration of each software program of integration system 10 (e.g., each software program that is intended to communicate information with other software programs).

Process 100 can include step 112, which include generating integration module 42 for each software program to communicate with another software program. Each integration module 42 that is generated can reference the information defined in landing zone configuration module 32A and/or integration pattern module 34A stored/saved in container registry 26. The referencing allows for integration module 42 to use the integration resource information 48 and integration pattern 50 without the need to include that information in integration module 42, thereby decreasing the amount of work that needs to be performed in step 112. The generation of integration module 42 in step 112 can include developing and/or introducing software program specific information 54 to integration module 42. Step 112 of generating integration module 42 for each software program to be integrated can be performed multiple times depending on the number of software programs that are to communicate with one another. Step 112 can be performed with integration module 42 in second repository 24, or integration module 42 can be generated, created, and/or modified when integration module 42 is located at any location, such as in cloud platform 20, stored locally by a user/client, or at another location. Additionally, the generation of integration module 42 can be performed and/or aided by using any useful and/or necessary computer programs (and similarly with modules 32, 34, and/or 40). Integration module 42 can be created anew in step 112, or all of integration module 42 or a portion of integration module 42 can be copied from another integration module that was generated for the integration of a previous software program, with the copied integration module 42 being supplemented with software program specific information 54 to enable the integration of the new software program.

Process 100 can then include step 114, which is downloading landing zone configuration module 32A and/or integration pattern module 34A to integration module 42. Step 114 can be prompted by a command within integration module 42 (e.g., software code that instructions a computer processor to download modules 32A and/or 34A to integration module 42). The commands can be performed by one or multiple integration resources 56 of cloud platform 20 and/or by other components. The performance of step 114 provides for integration module 42 to contain all information necessary to the integration of the software program into, for example, integration platform 30 as integration module 42 references the information in modules 32A and/or 34A. Landing zone configuration module 32A and/or integration pattern module 34A (or just the information therein) can be downloaded to integration module 42 when integration module 42 is in second repository 24 or at another location, such as in cloud platform 20. Step 114 can be performed automatically by a computer processor, such as one of integration resources 56, before or at the time of deployment of integration module 42.

After generating integration module 42 (step 112) and downloading landing zone configuration module 32 and integration pattern module 32 (step 114), process 100 includes step 116, which is deploying integration module 42 to cloud platform 20. Step 116 can include multiple sub-steps, such as step 116A, which is converting integration module 42 from Bicep language to Azure Resource Management (“ARM”) template language, and step 116B, which is performing instructions in integration module 42 by integration resources 56 to effectuate the integration of the software program.

Integration module 42 (as well as modules 32, 34, and/or 40) can be written/developed in Bicep language (or another coding language). In some examples of integration system 10 and/or integration process 100, integration module 42 may need to be converted from Bicep language (or another language) to a language acceptable by cloud platform 20. In the example shown and described with regards to FIGS. 1A and 1B, integration module 42 is converted/transpiled from Bicep language to ARM template language, which is a language used by Microsoft Azure. Sub-step 116A may also be performed during step 104 to convert integration workload module 40 into a language that is acceptable by cloud platform 20 and/or during other steps of process 100. For example, integration workload module 40 can be written/developed in Bicep language and converted/transpiled to ARM template language before or at the time of deployment to cloud platform 20. If module 40 and/or 42 is written/developed in a language acceptable by cloud platform 20, then sub-step 116A may not need to be performed during deployment to cloud platform 20. Sub-step 116A can also be performed automatically by a computer processor (or another component/system), such as by one or multiple integration resources 56.

Once converted into an acceptable language/format, deployment of integration module 42 (step 116) can include step 116B, which is performing the instructions set out in integration module 42 by cloud platform 20 (e.g., integration resources 56) to effectuate the integration of the software program (e.g., to perform the steps that allow for communication of the software program with another software program). The instructions performed by integration resources 56 as detailed in integration module 42 can be the integration pattern/process that sets out the process by which first software program 44 sends information to second software program 46. These instructions can continuously be performed to allow for continuously communication of first software program 44 with second software program 46, and the instructions can be saved in cloud platform 20 for continual use. Thus, upon deployment of integration module 42 (step 116), process 100 provides for the integration of multiple software programs with one another to allow for communication therebetween (by completing steps 112-116 multiple times for integration of new software programs).

Integration system 10 and integration process 100 are disclosed herein for developing an integration to allow multiple software programs to exchange information between each other automatically and in a format that is acceptable and useable by each software program. The disclosed example integration system 10 and integration process 100 can be configured to use cloud platform 20 (such as Microsoft Azure, Google Cloud Platform, Amazon Web Services, or others) to store data, perform instructions regarding integration, and effectuate the integration of the software programs (e.g., software programs 44 and/or 46). Integration system 10 and integration process 100 can use multiple software code/data modules/files, such as Bicep modules, to store and send data to integration platform 30 and/or cloud platform 20 (which can include a subscription, a workload configuration, and other components for accessing and managing the use of integration resources 56 within cloud platform 20) for performance of the integration of the software programs.

Modules 32, 34, 40, and 42 are used in the integration process. Integration workload module 42 is first deployed to cloud platform 20 to define landing zones 28, infrastructure resources 55, and/or integration resources 56 that are to be used to integrate the software programs, such as container registry 26 to which information/data can be saved and/or one or multiple computer processors to perform tasks/instructions for the integration of the software programs. Landing zone configuration module 32 defines integration resource information 48, which can include the names/locations of integration resources 56 to be used for each environment of the integration (as shown in FIG. 2 and having landing zones 28A and 28B), while integration pattern module 34 can define integration pattern 50 that establishes the core integration process for each integration of each software program (as shown in FIG. 3). Landing zone configuration module 32 and integration pattern module 34 can be uploaded to container registry 26 in cloud platform 20 (or saved/stored at another location) for later access by other components of integration system 10.

For each software program that is to communicate with another software program, one integration module 42 is generated and/or created that includes software program specific information 54 that is specific to the integration of the particular software program. This information 54 can include specific integration patterns that build upon core integration pattern 50 and is designed specifically for the software program. Software program specific information 54 can also include specific parameters detailing to which environment (e.g., development, test, or production) the integration of the software program is to be added/introduced.

Integration module 42 can reference landing zone configuration module 32 and integration pattern module 34 to use the information within both of those modules. For example, integration module 42 can use the information in landing zone configuration module 32 to set out the names/locations of integration resources 56 that are to be used to perform the integration of the software program, while integration module 42 can use the information in integration pattern module 34 to set out the core integration process that can be used for the integration of the software program. Integration module 42 for each software program is then deployed to cloud platform 20 for performance of the instructions therewithin for integration of the software program into, for example, integration platform 30 (e.g., performance of instructions that effectuate the communication of information between integrated software programs). However, before deployment, landing zone configuration module 32 and integration pattern module 34 are downloaded into (or the information in modules 32 and/or 34 are otherwise added to) integration module 42 such that all information needed to integrate the software program is contained within integration module 42. Once deployed, cloud platform 20 uses integration resources 56 to effectuate the integration of the software program by performing the instructions within integration module 42. Integration module 42 will define which integration resources 56 within cloud platform 20 are to perform which tasks to, among other things, effectuate the integration as well as where the information regarding the integration of the software program will be stored.

The generation and/or creation of integration module 42 is needed for each specific program that is to communicate with one another. However, landing zone workload module 40, landing zone configuration module 32, and integration pattern module 34 do not need to be created for each program but rather can be used/referenced multiple times by each integration module 42. Thus, each specific integration module 42 merely needs to reference landing zone configuration module 32 (to set out integration resource information 48, which can include the names/locations of integration resources 56 to be used for that particular integration) and integration pattern configuration 34 (to set out core integration pattern 50 to be used for that particular integration), and each specific integration module 42 does not need to define this information within the integration module 42. Thus, the creation of each integration module 42 is less burdensome and time-consuming, which is advantageous because the system (e.g., integration platform 30) can be developed to include dozens or hundreds of integrations (e.g., many software programs can be integrated into the system).

The following are nonlimiting examples of the system and related processes of integrating multiple software programs with one another to allow for communication therebetween:

A method of integrating multiple software programs with one another to allow for communication therebetween can include defining resource information regarding integration resources in a cloud platform for use in integrating the multiple software programs with the resource information being defined in a landing zone configuration module, defining an integration process in an integration pattern module with the integration pattern module referencing the resource information in the landing zone configuration module, uploading the landing zone configuration module and the integration pattern module to a container repository having storage media on the cloud platform, generating a first integration module having information specific to the integration of a first software program with the first integration module referencing the landing zone configuration module and the integration pattern module, automatically downloading, by a computer processor, the landing zone configuration module and the integration pattern module to the first integration module, and deploying the first integration module to the cloud platform that effectuates the integration of the first software program through use of the integration resources in the cloud platform with the integration resources being set out in the resource information in the landing zone configuration module.

The method can further include that the landing zone configuration module and the integration pattern module are each a Bicep module.

The method can further include that the integration process includes core steps to be taken to integrate the first software program, wherein the step of creating the first integration module further includes building upon the core steps set out in the integration process by introducing additional steps specific to integration of the first software program.

The method can further include defining, in an integration workload module, the integration resources in the cloud platform that are to be used to integrate the first software program and deploying the integration workload module to the cloud platform.

The method can further include that the container registry to which the landing zone configuration module and the integration pattern module are uploaded is defined in the integration workload module.

The method can further include creating a second integration module having information specific to the integration of a second software program with the second integration module referencing the landing zone configuration module and the integration pattern module, automatically downloading, by the computer processor, the landing zone configuration module and the integration pattern module to the second integration module, and deploying the second integration module to the cloud platform that effectuates the integration of the second software program through use of the integration resources in the cloud platform with the integration resources being set out in the resource information in the landing zone configuration module, wherein the first software program can send information to and receive information from second software program.

The method can further include that the information specific to the integration of the second software program includes an environment to which the second software program is to be integrated.

The method can further include that the landing zone configuration module, the integration pattern module, and the integration module are written in Bicep language.

The method can further include, during deployment of the integration module to the first integration landing zone subscription, converting the integration module from Bicep language to Azure Resource Manager (“ARM”) template language.

The method can further include that integration resources in the cloud platform includes multiple software programs and services and includes storage media and computer processors.

The method can further include that the cloud platform is Microsoft Azure.

The method can further include that the integration module is deployed to a landing zone in the cloud platform.

The method can further include that the resource information defined in the landing zone configuration module includes at least one of the following: application service resource group name, application service name, app service Linux name, shared resource group name, application programming interface management resource group name, service bus name, storage account name telemetry, storage account name data, key vault name, and key vault network name.

The method can further include that the step of deploying the integration module further includes accessing the integration module by a computer processor that is an integration resource in the cloud platform, downloading the landing zone configuration module and the integration pattern module from the container registry as referenced in the integration module, converting the integration module to Azure Resource Manager (“ARM”) template language, uploading the integration module to the cloud platform, and performing instructions within the integration module that effectuate the integration of the first software program.

The method can further include defining resource information, in the landing zone configuration module, for at least one environment of the integration platform to which the first software program is to be integrated, wherein the at least one environment is one of the following: a development environment, a test environment, and a production environment. The method can further include that the integration of the first software program includes receiving first software program data, reconfiguring the first software program data, and providing the reconfigured first software program data to at least one other software program of the multiple software programs.

A system for integrating multiple software programs with one another to allow for communication therebetween can include a landing zone configuration module that defines resource information regarding integration resources in a cloud platform for use in integrating the multiple software programs, an integration pattern module that defines a core integration process and that references the resource information in the landing zone configuration module, an integration module having information specific to the integration of a first software program with the integration module referencing the landing zone configuration module and the integration pattern module, a computer processor that automatically downloads the landing zone configuration module and the integration pattern module to the integration module such that all information within the landing zone configuration module and the integration pattern module are in the integration module at the time of deployment, and the cloud platform to which the integration module is deployed to effectuate the integration of the first software program through the use of integration resources in the cloud platform with the integration resources being set out in the resource information in the landing zone configuration module.

The system can further include that the landing zone configuration module, the integration pattern module, and the integration module are written in Bicep language.

The system can further include a container registry having storage media to which the landing zone configuration module and the integration pattern module are uploaded for access by the computer processor, wherein the computer processor automatically downloads the landing zone configuration module and the integration pattern module from the container registry.

The system can further include an integration workload module that defines the integration resources in the cloud platform that are to be used to integrate the first software program, wherein the integration workload module is deployed to the cloud platform to define the container registry within the cloud platform to which the landing zone configuration module and the integration pattern module are uploaded.

The system can further include a landing zone in the cloud platform to which the integration module is deployed to effectuate the integration, wherein the landing zone is within one of a development environment, a test environment, and a production environment.

While the invention has been described with reference to the above examples, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular examples disclosed, but that the invention will include all embodiments falling within the scope of the appended claims.

1. A method of integrating multiple software programs with one another to allow for communication therebetween, the method comprising:
defining resource information regarding integration resources in a cloud platform for use in integrating the multiple software programs, the resource information being defined in a landing zone configuration module;
defining an integration process in an integration pattern module, the integration pattern module referencing the resource information in the landing zone configuration module;
uploading the landing zone configuration module and the integration pattern module to a container repository having storage media on the cloud platform;
generating a first integration module having information specific to the integration of a first software program, the first integration module referencing the landing zone configuration module and the integration pattern module;
automatically downloading, by a computer processor, the landing zone configuration module and the integration pattern module to the first integration module; and
deploying the first integration module to the cloud platform that effectuates the integration of the first software program through use of the integration resources in the cloud platform with the integration resources being set out in the resource information in the landing zone configuration module.

2. The method of claim 1, wherein the landing zone configuration module and the integration pattern module are each a Bicep module.

3. The method of claim 1, wherein the integration process includes core steps to be taken to integrate the first software program, wherein the step of creating the first integration module further comprises:
building upon the core steps set out in the integration process by introducing additional steps specific to integration of the first software program.

4. The method of claim 1, further comprising:
defining, in an integration workload module, the integration resources in the cloud platform that are to be used to integrate the first software program; and
deploying the integration workload module to the cloud platform.

5. The method of claim 4, wherein the container registry to which the landing zone configuration module and the integration pattern module are uploaded is defined in the integration workload module.

6. The method of claim 1, further comprising:
creating a second integration module having information specific to the integration of a second software program, the second integration module referencing the landing zone configuration module and the integration pattern module;
automatically downloading, by the computer processor, the landing zone configuration module and the integration pattern module to the second integration module; and
deploying the second integration module to the cloud platform that effectuates the integration of the second software program through use of the integration resources in the cloud platform with the integration resources being set out in the resource information in the landing zone configuration module,
wherein the first software program can send information to and receive information from second software program.

7. The method of claim 6, wherein the information specific to the integration of the second software program includes an environment to which the second software program is to be integrated.

8. The method of claim 1, wherein the landing zone configuration module, the integration pattern module, and the integration module are written in Bicep language, the method further comprising:
during deployment of the integration module to the first integration landing zone subscription, converting the integration module from Bicep language to Azure Resource Manager (“ARM”) template language.

9. The method of claim 1, wherein integration resources in the cloud platform includes multiple software programs and services and includes storage media and computer processors.

10. The method of claim 1, wherein the cloud platform is Microsoft Azure.

11. The method of claim 10, wherein the integration module is deployed to a landing zone in the cloud platform.

12. The method of claim 1, wherein the resource information defined in the landing zone configuration module includes at least one of the following: application service resource group name, application service name, app service Linux name, shared resource group name, application programming interface management resource group name, service bus name, storage account name telemetry, storage account name data, key vault name, and key vault network name.

13. The method of claim 1, wherein the step of deploying the integration module further comprises:
accessing the integration module by a computer processor that is an integration resource in the cloud platform;
downloading the landing zone configuration module and the integration pattern module from the container registry as referenced in the integration module;
converting the integration module to Azure Resource Manager (“ARM”) template language;
uploading the integration module to the cloud platform; and
performing instructions within the integration module that effectuate the integration of the first software program.

14. The method of claim 1, further comprising:
defining resource information, in the landing zone configuration module, for at least one environment of the integration platform to which the first software program is to be integrated, wherein the at least one environment is one of the following: a development environment, a test environment, and a production environment.

15. The method of claim 1, wherein the integration of the first software program includes receiving first software program data, reconfiguring the first software program data, and providing the reconfigured first software program data to at least one other software program of the multiple software programs.

16. A system for integrating multiple software programs with one another to allow for communication therebetween, the system comprising:
a landing zone configuration module that defines resource information regarding integration resources in a cloud platform for use in integrating the multiple software programs;
an integration pattern module that defines a core integration process and that references the resource information in the landing zone configuration module;
an integration module having information specific to the integration of a first software program, the integration module referencing the landing zone configuration module and the integration pattern module;
a computer processor that automatically downloads the landing zone configuration module and the integration pattern module to the integration module such that all information within the landing zone configuration module and the integration pattern module are in the integration module at the time of deployment; and
the cloud platform to which the integration module is deployed to effectuate the integration of the first software program through the use of integration resources in the cloud platform with the integration resources being set out in the resource information in the landing zone configuration module.

17. The system of claim 16, wherein the landing zone configuration module, the integration pattern module, and the integration module are written in Bicep language.

18. The system of claim 16, further comprising:
a container registry having storage media to which the landing zone configuration module and the integration pattern module are uploaded for access by the computer processor,
wherein the computer processor automatically downloads the landing zone configuration module and the integration pattern module from the container registry.

19. The system of claim 18, further comprising:
an integration workload module that defines the integration resources in the cloud platform that are to be used to integrate the first software program,
wherein the integration workload module is deployed to the cloud platform to define the container registry within the cloud platform to which the landing zone configuration module and the integration pattern module are uploaded.

20. The system of claim 15, further comprising:
a landing zone in the cloud platform to which the integration module is deployed to effectuate the integration, wherein the landing zone is within one of a development environment, a test environment, and a production environment.
